(19) United States
(12) Patent Application Publication
(10) Pub. No.: US 2026/0007172 A1
(43) Pub. Date: Jan. 8, 2026

(54) CARTRIDGE AND AEROSOL GENERATING DEVICE INCLUDING THE SAME

(71) Applicant: KT&G CORPORATION, Daejeon (KR)

(72) Inventors: Won Kyeong LEE, Gyeonggi-do (KR); Soung Ho JU, Daejeon (KR); Min Kyu KIM, Seoul (KR)

(73) Assignee: KT&G CORPORATION, Daejeon (KR)

(21) Appl. No.: 18/993,548

(22) PCT Filed: Nov. 21, 2023
(86) PCT No.: PCT/KR2023/018747

§ 371 Date: Jan. 11, 2025

(30) Foreign Application Priority Data
Dec. 2, 2022 (KR) 10-2022-0167063
Jun. 9, 2023 (KR) 10-2023-0074398

(51) Int. Cl. A24F 40/46; A24F 40/10; A24F 40/42; A24F 40/44; A24F 40/485; H05B 3/00

(52) U.S. Cl. CPC A24F 40/46; A24F 40/10; A24F 40/42; A24F 40/44; A24F 40/485; H05B 3/0033; H05B 2214/04

(57) ABSTRACT

A cartridge includes a housing including a transmissive window through which external light penetrates into the cartridge. a storage arranged inside the housing and configured to store an aerosol generating material. a heating structure having a dome shape and including nanoparticles configured to generate heat according to surface plasmon resonance in response to receiving external light. and a wick including a first accommodation portion arranged to surround at least a portion of an outer circumferential surface of the heating structure and configured to supply the aerosol generating material stored in the storage to the heating structure, wherein the aerosol generating material transmitted from the storage to the heating structure through the wick is heated by the heat generated by the heating structure.

### TECHNICAL FIELD

One or more embodiments relate to a cartridge capable of generating an aerosol by heating an aerosol generating material by using a surface plasmon resonance technique and an aerosol generating device including the cartridge.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

Accordingly, various types of heaters for an aerosol generating device have been proposed. A recently suggested aerosol generating device employs surface plasmon resonance to heat an aerosol generating material.

Surface plasmon resonance is a technique used to heat metal through oscillation of nano-sized metal particles. Specifically, free electrons in nano-sized metal collectively oscillate in response to an external stimulus (e.g., incidence of light) such that the free electrons polarized by such oscillation heat the metal.

Because an aerosol generating device using the surface plasmon resonance may generate an aerosol with lower power consumption compared to aerosol generating devices employing heaters, there is a growing interest in the aerosol generating device using the surface plasmon resonance.

### DISCLOSURE OF INVENTION

### Technical Problem

An aerosol generating device using surface plasmon resonance may generate an aerosol by using nano-sized metal particles to heat a solid aerosol generating material inserted into the device, or a liquid aerosol generating material transmitted to metal particles from a storage through a wick.

In the case of the liquid aerosol generating material, the amount of aerosol (i.e., the amount of atomization) may increase in proportion to the amount of aerosol transmitted to metal particles. Thus, there is an increasing need for effective methods of transmitting an aerosol generating material to metal particles to improve smoking experience of a user.

The disclosure provides a cartridge with a structure, in which an arca and/or duration of contact of an aerosol generating material with metal particles may increase, and an aerosol generating device including the cartridge, such that the transmission efficiency of the aerosol generating material to the metal particles is improved and thus the amount of aerosol generation is increased.

The technical problems of the present disclosure are not limited to the above described description, and other technical problems may be clearly understood by one of ordinary skill in the art from the embodiments to be described hereinafter.

### Solution to Problem

According to an embodiment, a cartridge includes a housing including a transmissive window through which external light penetrates into the cartridge, a storage arranged inside the housing and configured to store an aerosol generating material, a heating structure having a dome shape and including nanoparticles configured to generate heat according to surface plasmon resonance in response to receiving the external light, and a wick including a first accommodation portion arranged to surround at least a portion of an outer circumferential surface of the heating structure and configured to supply the aerosol generating material stored in the storage to the heating structure, wherein the aerosol generating material transmitted from the storage to the heating structure through the wick is heated by the heat generated by the heating structure.

According to an embodiment, an aerosol generating device includes a main body including a light source, and a cartridge detachably coupled to the main body, wherein the cartridge includes a housing including a transmissive window through which light from the light source penetrates into the cartridge, a storage arranged inside the housing and configured to store an aerosol generating material, a heating structure having a dome shape and including nanoparticles configured to generate heat according to surface plasmon resonance upon receipt of light, and a wick including an accommodation portion arranged to surround at least a portion of an outer circumferential surface of the heating structure, and configured to supply the aerosol generating material stored in the storage to the heating structure, wherein the aerosol generating material transmitted from the storage to the heating structure through the wick is heated by the heat generated by the heating structure.

### Advantageous Effects of Invention

According to a cartridge and an aerosol generating device according to one or more embodiments, an aerosol generating material may be effectively delivered to a heating structure.

Also, according to a cartridge and an aerosol generating device according to one or more embodiments, the amount of aerosol generated may be increased by improving the efficiency of heating an aerosol generating material.

Effects of the embodiments are not limited to those stated above, and effects that are not described herein may be clearly understood by one of ordinary skill in the art from the present specification and the attached drawings.

### BRIEF DESCRIPTION OF DRAWINGS

FIG. 1 is a perspective view of an aerosol generating device according to an embodiment.

FIG. 2 is a cross-sectional view of an aerosol generating device according to an embodiment.

FIG. 3 is a diagram for explaining a process by which an aerosol generating material moves from a cartridge of the aerosol generating device of FIG. 2.

FIG. 4 is a diagram for explaining a process by which an aerosol generating material moves from a cartridge of an aerosol generating device according to another embodiment.

FIG. 5 is a diagram for explaining a process by which an aerosol is generated in the cartridge of the aerosol generating device of FIG. 2.

FIG. 6 is a cross-sectional view of an aerosol generating device according to another embodiment.

FIG. 7 is a cross-sectional view of an aerosol generating device according to another embodiment.

FIG. 8 is a diagram for explaining a process by which an aerosol is generated in a cartridge of the aerosol generating device of FIG. 7.

FIG. 9 is a block diagram of an aerosol generating device according to another embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates an aerosol by heating an aerosol generating article by using a surface plasmon resonance technique.

The aerosol generating device may include a light source configured to irradiate light according to a power supply thereto, and a heating structure including nano-sized metal particles that generate heat according to an external stimulus (e.g., light). Heat may be generated as free electrons within metal particles collectively oscillate in response to an external stimulus and are polarized, and an aerosol generating device may use heat generated by a heating structure to heat an aerosol generating article or an aerosol generating material absorbed into a wick, thus generating an aerosol.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, one or more embodiments of the disclosure are described in detail with reference to the attached drawings.

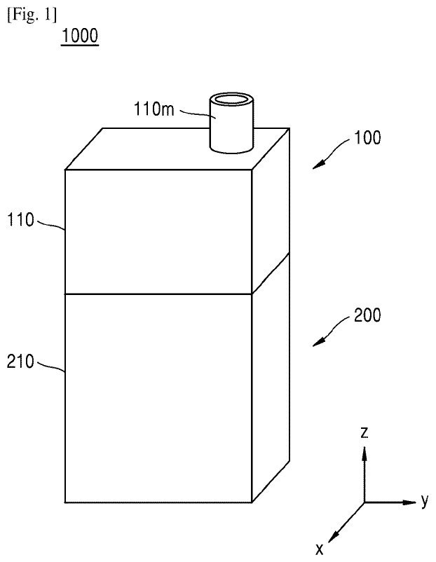

FIG. 1 is a perspective view of an aerosol generating device according to an embodiment.

Referring to FIG. 1, an aerosol generating device 1000 according to an embodiment may include a cartridge 100 and a main body 200 detachably coupled to the cartridge 100

The cartridge 100 may include a housing 110 forming an overall exterior of the cartridge 100. Components of the cartridge 100 for generating an aerosol may be arranged in an inner space of the housing 110.

For example, a storage that stores an aerosol generating material, a heating structure that generates heat according to an external stimulus (e.g., light), a wick that transmits the aerosol generating material in the storage to the heating structure, and other components may be arranged in the inner space of the housing 110, but the components of the cartridge 100 are not limited thereto.

The drawing illustrates that the housing 110 has a cuboid shape, but the shape is not limited thereto. According to an embodiment, the housing 110 may have a polyprism shape (e.g., a triangular pillar shape or an octagonal pillar shape) or a cylindrical shape.

According to an embodiment, the cartridge 100 may further include a mouthpiece 110m. For example, the mouthpiece 110m may be arranged on an end (e.g., an end in the +z direction) of the housing 110 and may provide fluid communication between the inner space of the housing 110 and the outside of the cartridge 100. However, the location of the mouthpiece 110m is not limited to the illustrated embodiment, and according to an embodiment, the mouthpiece 110m may be arranged on a portion of a side surface (e.g., a surface facing the +y direction) of the housing 110.

An aerosol generated inside the housing 110 of the cartridge 100 may be discharged to the outside of the cartridge 100 through the mouthpiece 110m, and the user may smoke by putting his/her mouth on the mouthpiece 110m to inhale the aerosol discharged to the outside of the cartridge 100.

The main body 200 may include a main body housing 210 detachably coupled to the housing 110 of the cartridge 100, and components of the main body 200 for general operations of the aerosol generating device 1000, which may be arranged in an inner space of the main body housing 210.

For example, a light source configured to irradiate light onto the heating structure, a battery for supplying power, and a processor may be arranged in the inner space of the main body housing 210, but the components of the main body 200 arranged in the inner space of the main body housing 210 are not limited thereto.

According to an embodiment, the main body 200 may further include a recess (not shown) for accommodating some portions of the cartridge 100. For example, the cartridge 100 may be coupled to the main body 200 in a manner that some portions of the cartridge 100 (e.g., a portion facing the −z direction) are detachably accommodated in the recess, but one or more embodiments are not limited thereto. In another embodiment, the main body 200 may further include a fixed member (not shown) that is detachably coupled to the housing 110 of the cartridge 100, and the cartridge 100 and the main body 200 may be coupled to or detached from each other as the user manipulates the fixed member.

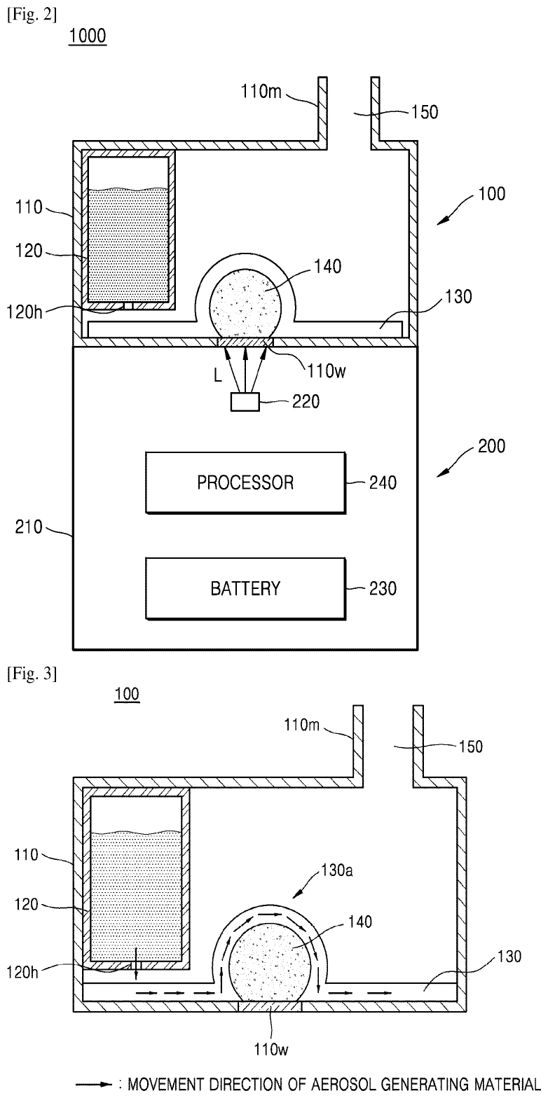

Hereinafter, with reference to FIGS. 2 to 5, the components of the aerosol generating device 1000 for generating an aerosol are described in detail.

FIG. 2 is a cross-sectional view of an aerosol generating device according to an embodiment. FIG. 2 is a cross-sectional view of the aerosol generating device 1000 of FIG. 1, taken along the y-z plane, according to an embodiment.

Referring to FIG. 2, the aerosol generating device 1000 according to an embodiment may include the cartridge 100 and the main body 200 detachably coupled to the cartridge 100. The components of the aerosol generating device 1000 according to an embodiment may be substantially the same as or similar to at least one of the components of the aerosol generating device 1000 of FIG. 1, and repeated descriptions are omitted hereinafter.

According to an embodiment, the cartridge 100 may include the housing 110 (e.g., the housing 110 of FIG. 1), a storage 120, a wick 130, and a heating structure 140.

The housing 110 may form the general exterior of the cartridge 100, and the housing 110 may include therein an inner space (or ‘accommodation space’) where the components of the cartridge 100 may be arranged.

According to an embodiment, the housing 110 may include the mouthpiece 110m and a transmissive window 110w.

The mouthpiece 110m may be arranged on a portion of the housing 110 to provide fluid communication between the inner space of the housing 110 and the outside of the cartridge 100, and the aerosol generated inside the housing 110 may be discharged to the outside of the cartridge 100 through the mouthpiece 110m.

When the cartridge 100 is coupled to the main body 200, the transmissive window 110w may be arranged on a portion of the housing 110 that faces the main body 200, and external light of the cartridge 100 may penetrate into the cartridge 100 through the transmissive window 110w. For example, light emitted from a light source 220 of the main body 200 may penetrate into the cartridge 100 through the transmissive window 110w.

The drawing illustrates that one transmissive window 110w is arranged on the housing 110, but the number of transmissive windows 110w is not limited thereto. According to an embodiment, a plurality of transmissive windows 110w may be arranged on a portion of the housing 110 that faces the main body 200.

The storage 120 may be arranged inside the housing 110, and an aerosol generating material may be stored in the storage 120. The aerosol generating material stored in the storage 120 may move towards the wick 130 because of gravity by passing through a hole 120h formed in a portion of the storage 120 that faces the wick 130, and the detailed description thereof is provided below.

In this case, the aerosol generating material may include a tobacco-containing material having a volatile tobacco flavor component, or a liquid composition including a non-tobacco material.

According to an embodiment, the liquid composition may include, for example, any one component of water, solvents, ethanol, plant extracts, spices, flavorings, and vitamin mixtures, or a mixture of these components. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected in consideration of the rate of nicotine absorption in the blood, the operating temperature of the aerosol generating apparatus 10, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

A portion of the wick 130 may be arranged adjacent to the storage 120, and another portion thereof is arranged to surround at least some portions of an outer circumferential surface of the heating structure 140, and thus, the wick 130 may deliver the aerosol generating material stored in the storage 120 to the heating structure 140.

For example, a portion of the wick 130 may be arranged to face the hole 120h of the storage 120, and thus, the wick 130 may absorb the aerosol generating material moving towards the wick 130 from the storage 120 because of gravity. The aerosol generating material absorbed into the wick 130 may move along the wick 130 in a direction towards the heating structure 140, and in the above manner, the wick 130 may deliver the aerosol generating material stored in the structure 120 to the heating structure 140.

For example, the wick 130 may be a cotton wick capable of absorbing the aerosol generating material, but the type of the wick 130 is not limited thereto. As another example, the wick 130 may be a ceramic wick.

The heating structure 140 may be arranged inside the housing 110 and generate heat by receiving external light penetrating into the housing 110 through the transmissive window 110w, thereby heating the aerosol generating material transmitted from the wick 130.

For example, as at least a portion of the wick 130 is arranged to surround at least a portion of the outer circumferential surface of the heating structure 140, the aerosol generating material absorbed into the wick 130 may be heated by the heat generated by the heating structure 140, and thus, aerosols may be generated. However, one or more embodiments are not limited thereto.

The heating structure 140 may include nano-sized metal particles (or ‘metal nanoparticles’) generating heat through surface plasmon resonance (SPR) by receiving light, and thus may heat the aerosol generating material using SPR.

In the present specification, ‘surface plasmon resonance’ refers to a phenomenon in which, when light is incident to a surface of a metal nanoparticle that is a conductor, free electrons on a metal surface collectively oscillate due to resonance between an electromagnetic field and specific energy of light. Also, ‘metal nanoparticles’ may refer to metal particles with a diameter in a nanoscale.

The free electrons on the surface of the metal nanoparticles of the heating structure 140 may collectively oscillate and be polarized in response to light entering the housing 110 through the transmissive light 110w according to SPR, and consequently, the metal nanoparticles of the heating structure 140 generate heat, which, in turn, heats the aerosol generating material absorbed into the wick 130.

For example, the heating structure 140 may have a dome shape, and at least a portion of the wick 130 may be arranged to surround the outer circumferential surface of the heating structure 140 having the dome shape. In this case, the heating structure 140 may use the light penetrating into the housing 110 to heat the aerosol generating material absorbed into the wick 130 surrounding the outer circumferential surface of the heating structure 140.

An aerosol may be generated from the aerosol generating material as the aerosol generating material is heated by the heating structure 140, and the generated aerosol may move towards the mouthpiece 110m along the airflow passage 150 that provides fluid communication between the inner space of the housing 110 and the mouthpiece 110m, and may be discharged to the outside of the cartridge 100 through the mouthpiece 110m.

According to an embodiment, the main body 200 may include a main body housing 210 (e.g., the main body housing 210 of FIG. 1), a light source 220, a battery 230, and a processor 240.

The main body housing 210 may form the overall exterior of the main body 200, and an inner space where components of the main body 200 may be arranged may be formed in the main body housing 210.

The light source 220 may be located in the inner space of the main body housing 210 and emit light L using power supplied from the battery 230. For example, the light source 220 may include a laser for irradiating light with a designated wavelength according to power supply, but the type of the light source 220 is not limited thereto.

According to an embodiment, the light source 220 may be arranged to face the transmissive window 110w of the cartridge 100 when the cartridge 100 is coupled to the main body 200, and may emit the light L towards the transmissive window 110w. However, the arrangement location of the light source 220 is not limited thereto.

The light L emitted from the light source 220 may reach the heating structure 140 after passing through the transmissive window 110w, and the heating structure 140 may generate heat using the light L emitted from the light source 220 and heat the aerosol generating material.

The battery 230 may supply power used to operate the aerosol generating device 1000. For example, the battery 230 may supply power to the light source 220 so that the light L may be emitted. As another example, the battery 230 may supply the power required for the operation of the processor 240.

In this case, the battery 230 may be a rechargeable battery or a disposable battery. For example, the battery 230 may be a lithium polymer (LiPoly) battery, but the type of the battery 230 is not limited thereto.

The controller 240 may control general operations of the aerosol generating device 1000. According to an embodiment, the processor 240 may be electrically or operatively connected to the light source 220 and control the operation of the light source 220. For example, the processor 240 may supply power to the light source 220 through the battery 230 and allow the light L to be emitted from the light source 220. As another example, the processor 240 may control the time taken to supply power to the light source 220 through the battery 230 and thus may control the time taken when the light L is emitted from the light source 220.

The process 240 may enable heat generation in the heating structure 140 through the above process or generally controls the duration during which the aerosol generating material is heated, but the control operation of the processor 240 is not limited thereto.

According to an embodiment, the processor 240 may include a plurality of processors 240. The processor 240 may be implemented as an array of a plurality of logic gates. The processor 240 may be implemented as a combination of a general-purpose microprocessor and a memory in which a program executable in the micro-processor is stored. Also, the processor 240 may be implemented in other forms of hardware.

FIG. 3 is a diagram for explaining a process by which an aerosol generating material moves from a cartridge of the aerosol generating device of FIG. 2. The solid arrow of FIG. 3 indicates a movement direction of the aerosol generating material.

Referring to FIG. 3, the cartridge 100 (or ‘a cartridge for an aerosol generating device’) may include the housing 110, the storage 120, the wick 130, and the heating structure 140. The components of the aerosol generating device 100 according to an embodiment may be substantially the same as or similar to at least one of the components of the aerosol generating device 100 of FIG. 2, and repeated descriptions are omitted hereinafter.

The storage 120 may be arranged in a direction towards an upper portion of the wick 130 (e.g., the z direction of FIG. 1) in the inner space of the housing 110, and the aerosol generating material in a liquid phase may be stored in the storage 120.

The hole 120h may be formed in a portion of the storage 120 that faces the wick 130, and the aerosol generating material stored in the storage 120 may be discharged to the outside of the storage 120 through the hole 120h. For example, the hole 120h may be formed in a portion of the bottom of the storage 120 that faces the wick 130, and the aerosol generating material stored in the storage 120 may pass through the hole 120 and move in the direction towards the wick 130 because of gravity.

The wick 130 may absorb the aerosol generating material supplied from the storage 120 and deliver the absorbed aerosol generating material in the direction towards the heating structure 140, thereby providing the aerosol generating material to the heating structure 140.

According to an embodiment, the wick 130 may primarily extend in a widthwise direction (e.g., the y-axis direction of FIG. 1) of the housing 110, while including an accommodation portion 130a for accommodating at least a portion of the outer circumferential surface of the heating structure 140. For example, the accommodation portion 130a of the wick 130 may be shaped in a dome corresponding to the outer circumferential surface of the heating structure 140 and may accommodate the outer circumferential surface of the heating structure 140 on the upper portion of the heating structure 140 (e.g., a portion in the +z direction of FIG. 1), but one or more embodiments are not limited thereto.

A portion (e.g., an end portion) of the wick 130 may be arranged under the hole 120h of the storage 120, and another portion (e.g., the other end portion) of the wick 130 may be arranged under the airflow passage 150 that is arranged opposite to the storage 120. In this case, the accommodation portion 130a of the wick 130 may be arranged between the opposite end portions of the wick 130 and accommodate the heating structure 140 having the dome shape.

The aerosol generating material stored in the storage 120 may be discharged to the outside of the storage 120 through the hole 120h, and the discharged aerosol generating material may be absorbed into one end portion of the wick 130 located under the storage 120. The aerosol generating material absorbed into one end portion of the wick 130 may move along the wick 130 in the direction towards the other end portion of the wick 130 and may be delivered to the heating structure 140.

As the wick 130 is arranged to surround the outer circumferential surface of the heating structure 140 having the dome shape through the accommodation portion 130a, an arca in which the aerosol generating material absorbed into the wick 130 is in contact with the heating structure 140 may increase, and as a result, the aerosol generating material absorbed into the wick 130 may be effectively supplied to the heating structure 140.

That is, the cartridge 100 according to an embodiment may stably and efficiently provide the aerosol generating material to the heating structure 140 through the heating structure 140 having the dome shape and the wick 130 including the accommodation portion 130a surrounding the outer circumferential surface of the heating structure 140 having the dome shape. As a result, the cartridge 100 according to an embodiment may increase the amount of aerosol generated, thus improving the smoking experience of the user.

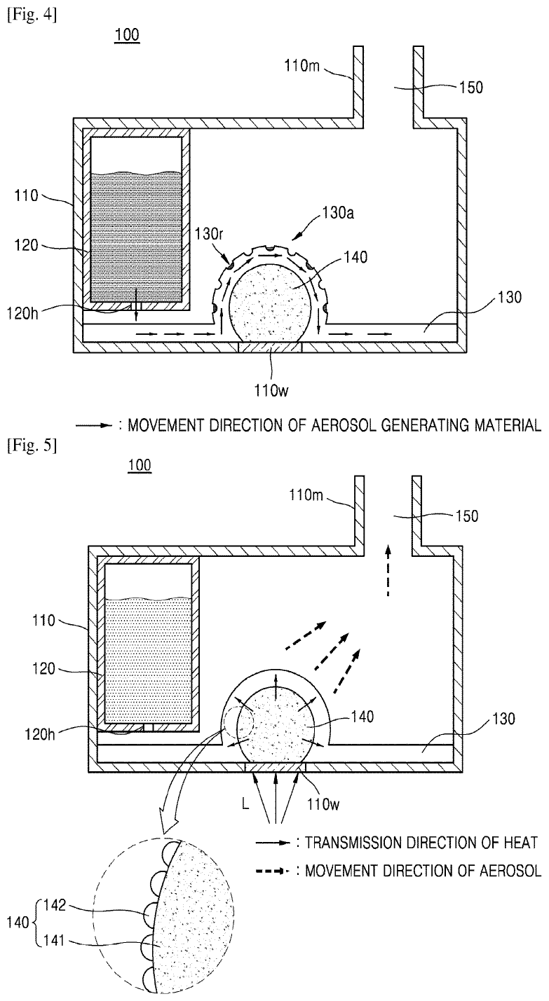

FIG. 4 is a diagram for explaining a process by which an aerosol generating material moves from a cartridge of an aerosol generating device according to another embodiment. The solid arrow of FIG. 4 indicates a movement direction of the aerosol generating material.

Referring to FIG. 4, the cartridge 100 according to another embodiment may include a housing 110, a storage 120, a wick 130, and a heating structure 140. The cartridge 100 according to another embodiment may be a cartridge in which at least one concave portion 130r is added to the cartridge 100 of FIG. 3, and repeated descriptions are omitted hereinafter.

According to another embodiment, the wick 130 may include an accommodation portion 130a (e.g., the accommodation portion 130a of FIG. 3) for accommodating the heating structure 140 having the dome shape, and at least one concave portion 130r arranged on an outer circumferential surface of the accommodation portion 130a.

At least one concave portion 130r may be arranged along the outer circumferential surface of the accommodation portion 130a having the dome shape, and part of the aerosol generating material moving along the wick 130 may be collected in the at least one concave portion 130r.

For example, the at least one concave portion 130r may be concave in a direction towards the heating structure 140 from the outer circumferential surface of the accommodation portion 130a. The concave portion 130r may have a “U” shape to collect a great amount of aerosol generating material, but the shape of the concave portion 130r is not limited thereto.

As part of the aerosol generating material moving from one end portion of the wick 130 to the other end portion is collected in the at least one concave portion 130r, a duration during which the heating structure 140 contacts the aerosol generating material may increase, and consequently, the aerosol generating material may be rather effectively provided to the heating structure 140.

That is, the cartridge 100 according to another embodiment may increase the area and duration of contact of the aerosol generating material with the heating structure 140 through the wick 130 including the accommodation portion 130a and at least one concave portion 130r and may improve the efficiency of providing the aerosol generating material to the heating structure 140, resulting in the increase in the amount of generated aerosol.

FIG. 5 is a diagram for explaining a process by which an aerosol is generated in the cartridge of the aerosol generating device of FIG. 2. The solid arrow of FIG. 5 indicates a direction in which heat generated by the heating structure 140 is transmitted, and a dashed arrow indicates a direction in which an aerosol moves.

Referring to FIG. 5, the cartridge 100 according to an embodiment may include a housing 110, a storage 120, a wick 130, and a heating structure 140. The components of the aerosol generating device 100 according to an embodiment may be substantially the same as or similar to at least one of the components of the aerosol generating device 100 of FIGS. 2 to 4, and repeated descriptions are omitted hereinafter. That is, although not shown in the drawing, the wick 130 may further include at least one concave portion (e.g., at least one concave portion 130r of FIG. 4) as illustrated in FIG. 4.

At least a portion of the heating structure 140 is arranged to face the transmissive window 110w in the inner space of the housing 110, and as the light L penetrating into the housing 110 through the transmissive window 11w is received, the heating structure 140 may generate heat and then heat the aerosol generating material.

According to an embodiment, the heating structure 140 may include a substrate 141 and a plurality of metal nanoparticles 142 arranged on the substrate 141.

The substrate 141 may have a dome shape, and the metal nanoparticles 142 may be arranged on the outer circumferential surface of the substrate 141 having the dome shape such that the heating structure 140 may have an overall dome shape.

The metal nanoparticles 142 may receive the light L emitted from a light source (e.g., the light source 220 of FIG. 2) of a main body (e.g., the main body 200 of FIG. 2) and generate heat according to SPR.

The free electrons of the metal nanoparticle 142 may collectively oscillate because of SPR as the light L traveling to the inside of the housing 110 is received through the transmissive window 110w. The metal nanoparticles 142 may be polarized through the collective oscillation of the free electrons of the metal nanoparticles 142 and generate heat, and the heat generated by the metal nanoparticles 142 may be transmitted to the wick 130 surrounding the outer circumferential surface of the heating structure 140.

According to an embodiment, the metal nanoparticles 142 may generate heat by oscillating by light in the same wavelength, but one or more embodiments are not limited thereto. In another embodiment, the metal nanoparticles 142 may include a plurality of types of metal nanoparticles that oscillate by light of different wavelengths. For example, the metal nanoparticles 142 may include first metal nanoparticles generating heat through oscillation when exposed to light in a first wavelength, and second metal nanoparticles generating heat through oscillation when exposed to light in a second wavelength that is different from the first wavelength.

The aerosol generating material released from the storage 120 and absorbed into the wick 130 may be heated by the heat transmitted from the metal nanoparticles 142 of the heating structure 140, and thus, vapor may be generated from the aerosol generating material. For example, as the wick 130 is arranged to contact the outer circumferential surface of the heating structure 140, the heat generated by the metal nanoparticles 142 of the heating structure 140 may be transmitted to the wick 130, and the aerosol generating material absorbed into the wick 130 may be heated by the transmitted heat.

The vapor generated from the aerosol generating material may be mixed with air flowing into the housing 110 through the airflow passage 150 or a separate air inlet (not shown), and thus, the aerosol may be generated in the inner space of the housing 110.

In the present specification, the term ‘aerosol’ may refer to fine particles in which air is mixed with the vapor generated from the aerosol generating material.

The aerosol generated inside the housing 110 may be discharged to the outside of the cartridge 100 through the mouthpiece 110m after moving towards the mouthpiece 110m along the airflow passage 150 arranged opposite to the storage 120 with respect to the wick 130. In this case, the user may smoke by putting his/her mouth on the mouthpiece 110m and then inhaling the aerosol discharged to the outside of the cartridge 100.

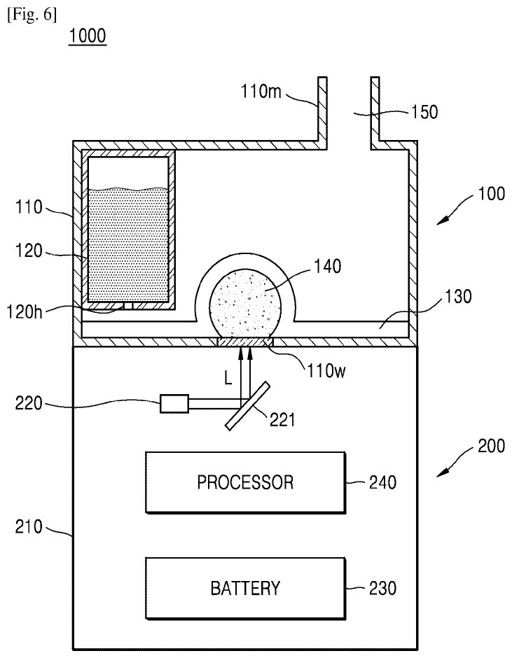

FIG. 6 is a cross-sectional view of an aerosol generating device according to another embodiment. FIG. 6 is a cross-sectional view of the aerosol generating device 1000 of FIG. 1, taken along the y-z plane, according to another embodiment.

Referring to FIG. 6, an aerosol generating device 1000 according to another embodiment may include a cartridge 100 and a main body 200 detachably coupled to the cartridge 100. The aerosol generating device 1000 according to another embodiment may be a device in which the location of the light source 220 is changed and a reflection member 221 is only added to the aerosol generating device 1000 of FIG. 2, and thus repeated descriptions are omitted hereinafter.

According to another embodiment, the main body 200 may include a main body housing 210 (e.g., the main body housing 210 of FIG. 2), a light source 220, at least one reflection member 221, a battery 230 (e.g., the battery 230 of FIG. 2), and a processor 240 (e.g., the processor 240 of FIG. 2).

The light source 220 may be located in the inner space of the main body housing 210 and emit light L to the at least one reflection member 221 using the power supplied from the battery 230. For example, when the cartridge 100 is coupled to the main body 200, the light source 220 may be arranged on a portion of the main body housing 110 that does not overlap the transmissive window 110w, and may emit light towards the at least one reflection member 221.

In the present specification, the description ‘the light source 220 is arranged not to overlap the transmissive window 110w’ may indicate that the light source 220 and the transmissive window 110w are not on the same line that extends in a lengthwise direction of the aerosol generating device 1000 (e.g., the z-axis direction in FIG. 1).

The at least one reflection member 221 may be arranged in the inner space of the main body housing 110 to change the movement direction of the light L emitted from the light source 220. For example, the at least one reflection member 221 may change the movement direction of the light L, which is emitted from the light source 220, to a direction towards the transmissive window 110w of the cartridge 100.

According to an embodiment, at least one reflection member 221 may include a mirror for reflecting incident light, but is not limited thereto. The reflection member 221 may include other components that may change a movement direction of incident light. In addition, the drawing illustrates that one reflection member 221 is arranged, but the number of reflection members 221 is not limited thereto.

The aerosol generating device 1000 according to another embodiment may enable light to be incident to the transmissive window 110w through at least one reflection member 221 even though the light source 220 is not arranged to face the transmissive window 110w. As a result, in the aerosol generating device 1000 according to another embodiment, the freedom degree of the arrangement configuration or installation configuration of the components of the main body 200 in the main body housing 210 may increase.

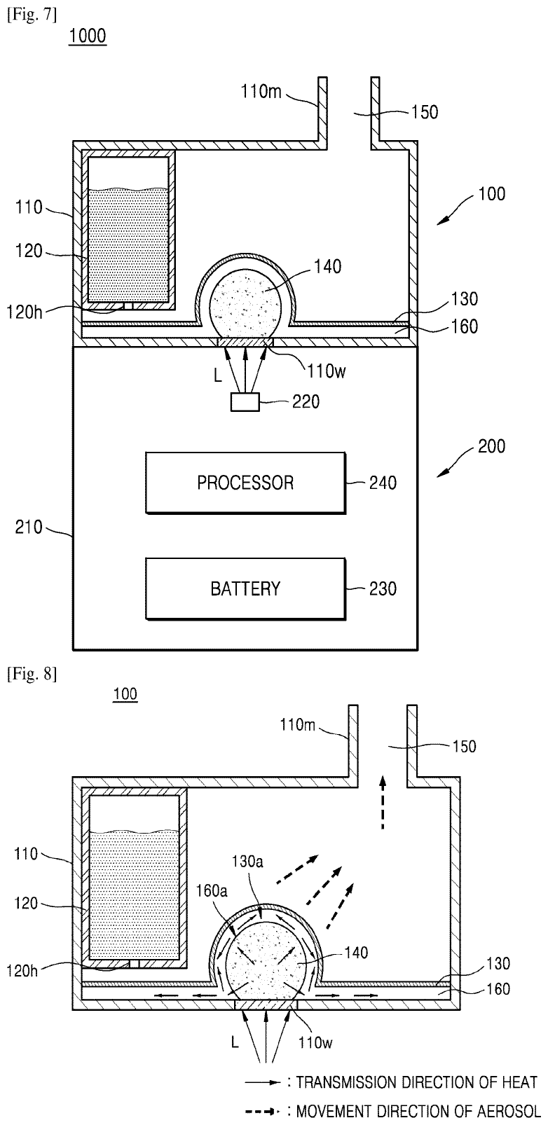

FIG. 7 is a cross-sectional view of an aerosol generating device according to another embodiment. FIG. 7 is a cross-sectional view of the aerosol generating device 1000 of FIG. 1, taken along the y-z plane, according to another embodiment.

Referring to FIG. 7, an aerosol generating device 1000 according to another embodiment may include a cartridge 100 and a main body 200 detachably coupled to the cartridge 100. The aerosol generating device 1000 according to another embodiment may be a device in which a heat-conducting member 160 is added to the aerosol generating device 1000 of FIG. 2, and repeated descriptions are omitted hereinafter.

According to an embodiment, the cartridge 100 may include a housing 110 (e.g., the housing 110 of FIG. 2), a storage 120 (e.g., the storage 120 of FIG. 2), a wick 130 (e.g., the wick 130 of FIGS. 2 to 4), a heating structure 140 (e.g., the heating structure 140 of FIG. 2), and the heat-conducting member 160.

The housing 110 may form the overall exterior of the cartridge 100 and may include the mouthpiece 110m, which provides fluid communication between the inner space of the housing 110 and the outside of the cartridge 100, and the transmissive window 110w for introducing external light to the inner space of the housing 110. For example, when the cartridge 100 is coupled to the main body 200, light L emitted from the light source 220 of the main body 200 may enter the inner space of the housing 110 through the transmissive window 110w.

The storage 120 may be arranged in the inner space of the housing 110, and an aerosol generating material in a liquid phase may be stored in the storage 120. A hole 120h may be formed in a portion of the storage 120 that faces the wick 130, and the aerosol generating material stored in the storage 120 may move towards the wick 130 after passing through the hole 120h due to gravity.

The wick 130 may absorb the aerosol generating material supplied from the storage 120 and deliver the absorbed aerosol generating material in the direction towards the heating structure 140, thereby providing the aerosol generating material to the heating structure 140.

For example, a portion (e.g., end portion) of the wick 130 is arranged under the hole 120h of the storage 120, and thus, the wick 130 may absorb the aerosol generating material discharged to the outside of the storage 120 through the hole 120h. The aerosol generating material absorbed into the end portion of the wick 130 may move along the wick 130 in the direction towards the other end portion of the wick 130.

The heating structure 140 may be arranged inside the housing 110 and generate heat by receiving external light penetrating into the housing 110 through the transmissive window 110w. For example, at least a portion of the heating structure 140 may be arranged to face the transmissive window 110w of the housing 110, and thus, the heating structure 140 may receive the light L emitted from the light source 220 of the main body 200.

According to an embodiment, the heating structure 140 may generate heat according to SPR because of metal nanoparticles (e.g., the metal nanoparticles 142 of FIG. 5) in the heating structure 140 that generate heat upon receiving light.

The heat-conducting member 160 may be arranged between the wick 130 and the heating structure 140 in the inner space of the housing 110 and configured to deliver the heat generated by the heating structure 140 to the wick 130. For example, the heat-conducting member 160 may include metal (e.g., aluminum or copper) with high heat conductivity to transmit the heat generated by the heating structure 140 to the wick 130, but the type of the heat-conducting member 160 is not limited thereto.

At least some portions of the heat-conducting member 160 may be arranged to surround the outer circumferential surface of the heating structure 140, and the wick 130 may be formed in a shape corresponding to the heat-conducting member 160 to surround the outer circumferential surface of the heat-conducting member 160 surrounding the heating structure 140.

That is, the heating structure 140, the heat-conducting member 160, and the wick 130 may be sequentially stacked, and based on the arrangement described above, the heat generated by the heating structure 140 according to SPR may be transmitted to the wick 130 through the heat-conducting member 160.

As the aerosol generating material absorbed into the wick 130 is heated by the heat transmitted through the heat-conducting member 160, an aerosol may be generated from the aerosol generating material, and the generated aerosol may move along the airflow passage 150 in the direction towards the mouthpiece 110m and be discharged to the outside of the cartridge 100.

Although not shown in the drawing, the wick 130 may further include at least one concave portion (e.g., the concave portion 130r of FIG. 4) formed on the outer circumferential surface of the wick 130 to increase the duration during which the heat-conducting member 160 contacts the aerosol generating material.

Hereinafter, a process by which the heat generated by the heating structure 140 is transmitted to the aerosol generating material absorbed into the wick 130 through the heat-conducting member 160 is described in detail with reference to FIG. 8.

FIG. 8 is a diagram for explaining a process by which an aerosol is generated in a cartridge of the aerosol generating device of FIG. 7.

Referring to FIG. 8, the cartridge 100 according to an embodiment may include the housing 110, the storage 120, the wick 130, the heating structure 140, and the heat-conducting member 160. The components of the aerosol generating device 100 according to an embodiment may be substantially the same as or similar to at least one of the components of the aerosol generating device 100 of FIG. 7, and repeated descriptions are omitted hereinafter.

The wick 130 may absorb the aerosol generating material discharged to the outside of the storage 120 through the hole 120h. For example, a portion (e.g., an end portion) of the wick 130 may be arranged under the hole 120h of the storage 120 and absorb the aerosol generating material discharged from the storage 120, and the aerosol generating material absorbed into the portion of the wick 130 may move along the wick 130 in the direction towards another portion (e.g., the other end portion) of the wick 130.

A portion of the heating structure 140 may be arranged to face the transmissive window 110w in the inner space of the housing 110, and the heating structure 140 may generate heat upon receiving the light L penetrating into the housing 110 through the transmissive window 110w.

According to an embodiment, the heating structure 140 may include the substrate (e.g., the substrate 141 of FIG. 5) having the dome shape, and the metal nanoparticles (e.g., the metal nanoparticles 142 of FIG. 5) arranged on the outer circumferential surface of the substrate having the dome shape. The metal nanoparticles may receive the light L emitted from the light source (e.g., the light source 220 of FIG. 2) of the main body (e.g., the main body 200 of FIG. 2) and generate heat according to SPR.

The heat-conducting member 160 may be arranged between the wick 130 and the heating structure 140 and transmit the heat generated by the heating structure 140 to the wick 130. For example, the heat-conducting member 160 may be arranged such that a first surface (e.g., a surface facing the +z direction of FIG. 1) of the heat-conducting member 160 may contact the wick 130 and a second surface, opposite to the first surface, contacts the heating structure 140. As such, the heat-conducting member 160 may transmit the heat generated by the heating structure 140 to the wick 130.

According to an embodiment, the wick 130 may include a first accommodation portion 130a, and the heat-conducting member 160 may include a second accommodation portion 160a.

The second accommodation portion 160a of the heat-conducting member 160 may have a shape (e.g., a dome shape) corresponding to the outer circumferential surface of the heating structure 140 having the dome shape and may be arranged to surround at least some portions of the outer circumferential surface of the heating structure 140.

Also, the first accommodation portion 130a of the wick 130 may have a shape (e.g., a dome shape) corresponding to the outer circumferential surface of the second accommodation portion 160a and may be arranged to surround the outer circumferential surface of the second accommodation portion 160a accommodating the outer circumferential surface of the heating structure 140.

Based on the above-described arrangement, the heat generated by the heating structure 140 according to SPR may be transmitted to the second accommodation portion 160a of the heat-conducting member 160 that contacts the heating structure 140. The heat transmitted to the second accommodation portion 160a may be transmitted to the entire area of heat-conducting member 160, and the heat transmitted to the entire heat-conducting member 160 may be transmitted to the wick 130 contacting the heat-conducting member 160.

The aerosol generating material absorbed into the wick 130 may be heated by the heat transmitted from the heat-conducting member 160, and thus, vapor may be generated from the aerosol generating material. The vapor generated from the aerosol generating material may be mixed with air flowing into the housing 110 through the airflow passage 150 or a separate air inlet (not shown) to generate an aerosol, and the generated aerosol may be discharged to the outside of the cartridge 100 through the mouthpiece 110m after moving along the airflow passage 150 in the direction towards the mouthpiece 110m. In this case, the user may smoke by putting his/her mouth on the mouthpiece 110m and then inhaling the aerosol discharged to the outside of the cartridge 100.

The cartridge 100 according to an embodiment may increase an area, where the aerosol generating material is heated, by allowing the heat generated by the heating structure 140 to be delivered to the entire wick 130 through the heat-conducting member 160, and as a result, the cartridge 100 may generate a greater amount of aerosol with the same power, improving the smoking experience of the user.

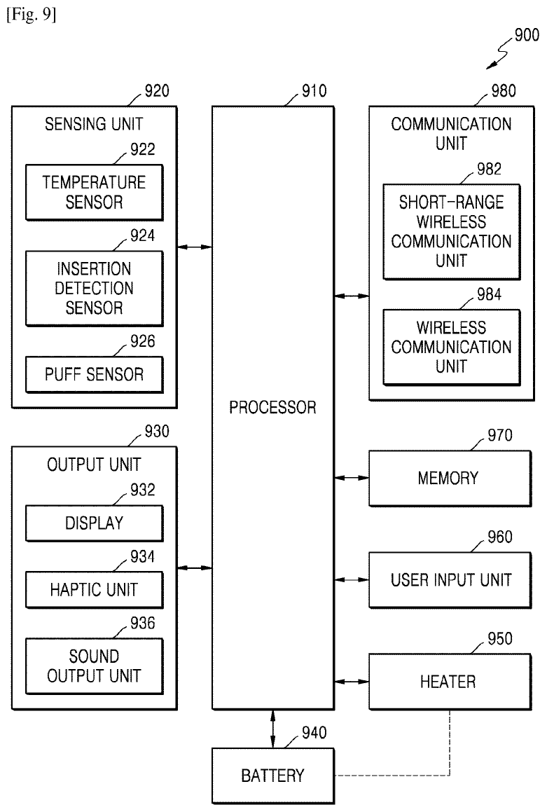

FIG. 9 is a block diagram of an aerosol generating device according to an embodiment.

The aerosol generating device 900 may include a controller 910, a sensing unit 920, an output unit 930, a battery 940, a heater 950, a user input unit 960, a memory 970, and a communication unit 980. However, the internal structure of the aerosol generating device 900 is not limited to those illustrated in FIG. 9. That is, according to the design of the aerosol generating device 900, it will be understood by one of ordinary skill in the art that some of the components shown in FIG. 9 may be omitted or new components may be added.

The sensing unit 920 may sense a state of the aerosol generating device 900 and a state around the aerosol generating device 900, and transmit sensed information to the controller 910. Based on the sensed information, the controller 910 may control the aerosol generating device 900 to perform various functions, such as controlling an operation of the heater 950, limiting smoking, determining whether an aerosol generating article (e.g., a cigarette, a cartridge, or the like) is inserted, displaying a notification, or the like.

The sensing unit 920 may include at least one of a temperature sensor 922, an insertion detection sensor, and a puff sensor 926, but is not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 may serve as a temperature sensor. Alternatively, the temperature sensor 922 may also be arranged around the battery 940 to monitor the temperature of the battery 940.

The insertion detection sensor 924 may sense insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 926 may sense a user's puff on the basis of various physical changes in an airflow passage or an airflow channel. For example, the puff sensor 926 may sense a user's puff on the basis of any one of a temperature change, a flow change, a voltage change, and a pressure change.

The sensing unit 920 may include, in addition to the temperature sensor 922, the insertion detection sensor 924, and the puff sensor 926 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 930 may output information on a state of the aerosol generating device 900 and provide the information to a user. The output unit 930 may include at least one of a display unit 932, a haptic unit 934, and a sound output unit 936, but is not limited thereto. When the display unit 932 and a touch pad form a layered structure to form a touch screen, the display unit 932 may also be used as an input device in addition to an output device.

The display unit 932 may visually provide information about the aerosol generating device 900 to the user. For example, information about the aerosol generating device 900 may mean various pieces of information, such as a charging/discharging state of the battery 940 of the aerosol generating device 900, a preheating state of the heater 950, an insertion/removal state of an aerosol generating article, or a state in which the use of the aerosol generating device 900 is restricted (e.g., sensing of an abnormal object), or the like, and the display unit 932 may output the information to the outside. The display unit 932 may be, for example, a liquid crystal display panel (LCD), an organic light-emitting diode (OLED) display panel, or the like. In addition, the display unit 932 may be in the form of a light-emitting diode (LED) light-emitting device.

The haptic unit 934 may tactilely provide information about the aerosol generating device 900 to the user by converting an electrical signal into a mechanical stimulus or an electrical stimulus. For example, the haptic unit 934 may include a motor, a piezo-electric element, or an electrical stimulation device.

The sound output unit 936 may audibly provide information about the aerosol generating device 900 to the user. For example, the sound output unit 936 may convert an electrical signal into a sound signal and output the same to the outside.

The battery 940 may supply power used to operate the aerosol generating device 900. The battery 940 may supply power such that the heater 950 may be heated. In addition, the battery 940 may supply power required for operations of other components (e.g., the sensing unit 920, the output unit 930, the user input unit 960, the memory 970, and the communication unit 980) in the aerosol generating device 900. The battery 940 may be a rechargeable battery or a disposable battery. For example, the battery 940 may be a lithium polymer (LiPoly) battery, but is not limited thereto.

The heater 950 may receive power from the battery 940 to heat an aerosol generating material. Although not illustrated in FIG. 9, the aerosol generating device 900 may further include a power conversion circuit (e.g., a direct current (DC)/DC converter) that converts power of the battery 940 and supplies the same to the heater 950. In addition, when the aerosol generating device 900 generates aerosols in an induction heating method, the aerosol generating device 900 may further include a DC/alternating current (AC) that converts DC power of the battery 940 into AC power.

The controller 910, the sensing unit 920, the output unit 930, the user input unit 960, the memory 970, and the communication unit 980 may each receive power from the battery 940 to perform a function. Although not illustrated in FIG. 9, the aerosol generating device 900 may further include a power conversion circuit that converts power of the battery 940 to supply the power to respective components, for example, a low dropout (LDO) circuit, or a voltage regulator circuit.

In an embodiment, the heater 950 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 950 may be implemented by a metal wire, a metal plate on which an electrically conductive track is arranged, a ceramic heating element, or the like, but is not limited thereto.

In another embodiment, the heater 950 may be a heater of an induction heating type. For example, the heater 950 may include a suspector that heats an aerosol generating material by generating heat through a magnetic field applied by a coil.

According to another embodiment, the heater 950 may be a heater using SPR. For example, when receiving light, the heater 950 may generate heat according to SPR and thus heat the aerosol generating material.

The user input unit 960 may receive information input from the user or may output information to the user. For example, the user input unit 960 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 900 may further include a connection interface, such as a universal serial bus (USB) interface, and may connect to other external devices through the connection interface, such as the USB interface, to transmit and receive information, or to charge the battery 940.

The memory 970 is a hardware component that stores various types of data processed in the aerosol generating device 900, and may store data processed and data to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operation time of the aerosol generating device 900, the maximum number of puffs, the current number of puffs, at least one temperature profile, data on a user's smoking pattern, etc.

The communication unit 980 may include at least one component for communication with another electronic device. For example, the communication unit 980 may include a short-range wireless communication unit 982 and a wireless communication unit 984.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 984 may include a cellular network communication unit, an Internet communication unit, a computer network (e.g., local area network (LAN) or wide area network (WAN)) communication unit, or the like, but is not limited thereto. The wireless communication unit 984 may also identify and authenticate the aerosol generating device 900 within a communication network by using subscriber information (e.g., International Mobile Subscriber Identifier (IMSI)).

The controller 910 may control general operations of the aerosol generating device 900. In an embodiment, the controller 910 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 910 may control the temperature of the heater 950 by controlling supply of power of the battery 940 to the heater 950. For example, the controller 910 may control power supply by controlling switching of a switching element between the battery 940 and the heater 950. In another example, a direct heating circuit may also control power supply to the heater 950 according to a control command of the controller 910.

The controller 910 may analyze a result sensed by the sensing unit 920 and control subsequent processes to be performed. For example, the controller 910 may control power supplied to the heater 950 to start or end an operation of the heater 950 on the basis of a result sensed by the sensing unit 920. As another example, the controller 910 may control, based on a result sensed by the sensing unit 920, an amount of power supplied to the heater 950 and the time the power is supplied, such that the heater 950 may be heated to a certain temperature or maintained at an appropriate temperature.

The controller 910 may control the output unit 930 on the basis of a result sensed by the sensing unit 920. For example, when the number of puffs counted through the puff sensor 926 reaches a preset number, the controller 910 may notify the user that the aerosol generating device 900 will soon be terminated through at least one of the display unit 932, the haptic unit 934, and the sound output unit 936.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. A cartridge comprising:
a housing comprising a transmissive window through which external light penetrates into the cartridge;
a storage arranged inside the housing and configured to store an aerosol generating material;
a heating structure having a dome shape and comprising nanoparticles configured to generate heat according to surface plasmon resonance in response to receiving the external light; and
a wick comprising a first accommodation portion arranged to surround at least a portion of an outer circumferential surface of the heating structure, and configured to supply the aerosol generating material stored in the storage to the heating structure, wherein the aerosol generating material transmitted from the storage to the heating structure through the wick is heated by the heat generated by the heating structure.

2. The cartridge of claim 1, further comprising an airflow passage arranged to provide fluid communication between an inside of the housing and an outside of the housing, wherein an aerosol is generated as the aerosol generating material is heated by the heat generated by the heating structure, and is discharged to an outside of the cartridge through the airflow passage.

3. The cartridge of claim 2, wherein the storage and the airflow passage are arranged in opposite directions relative to the wick.

4. The cartridge of claim 1, wherein at least a portion of the heating structure is arranged to face the transmissive window.

5. The cartridge of claim 1, wherein the first accommodation portion is formed in the dome shape corresponding to the outer circumferential surface of the heating structure.

6. The cartridge of claim 1, wherein the wick comprises at least one concave portion arranged on an outer circumferential surface of the first accommodation portion, and configured to collect at least part of the aerosol generating material absorbed into the wick.

7. The cartridge of claim 1, further comprising a heat-conducting member configured to transmit the heat generated by the heating structure to the wick, and disposed between the wick and the heating structure such that one surface of the heat-conducting member is in contact with the outer circumferential surface of the heating structure and another surface of the heat-conducting member opposite to the one surface is in contact the wick.

8. The cartridge of claim 7, wherein
the heat-conducting member comprises a second accommodation portion arranged to surround the portion of the outer circumferential surface of the heating structure, and
the first accommodation portion of the wick is formed in a shape corresponding to an outer circumferential surface of the second accommodation portion and arranged to surround an outer circumferential surface of the second accommodation portion.

9. An aerosol generating device comprising:
a main body comprising a light source; and
a cartridge detachably coupled to the main body,
wherein the cartridge comprises:
a housing comprising a transmissive window through which light from the light source penetrates into the cartridge;
a storage arranged inside the housing and configured to store an aerosol generating material;
a heating structure having a dome shape and comprising nanoparticles configured to generate heat according to surface plasmon resonance upon receipt of light; and
a wick comprising an accommodation portion arranged to surround at least a portion of an outer circumferential surface of the heating structure, and configured to supply the aerosol generating material stored in the storage to the heating structure,
wherein the aerosol generating material transmitted from the storage to the heating structure through the wick is heated by the heat generated by the heating structure.

10. The aerosol generating device of claim 9, wherein the cartridge further comprises an airflow passage configured to provide fluid communication between an inside of the housing and an outside of the housing, and
an aerosol is generated as the aerosol generating material is heated by the heat generated by the heating structure, and is discharged to an outside of the cartridge through the airflow passage.

11. The aerosol generating device of claim 9, wherein at least a portion of the heating structure is arranged to face the transmissive window and receive the light emitted from the light source through the transmissive window.

12. The aerosol generating device of claim 9, wherein the light source is arranged to face the transmissive window when the cartridge is coupled to the main body.

13. The aerosol generating device of claim 9, wherein the main body further comprises at least one reflection member configured to change a path of the light emitted from the light source towards the transmissive window.

14. The aerosol generating device of claim 9, wherein the wick comprises at least one concave portion arranged on an outer circumferential surface of the accommodation portion, and configured to collect at least part of the aerosol generating material absorbed into the wick.

15. The aerosol generating device of claim 9, wherein the cartridge further comprises a heat-conducting member configured to transmit the heat generated by the heating structure in response to the light emitted from the light source to the wick, and disposed between the wick and the heating structure such that one surface of the heat-conducting member is in contact with the outer circumferential surface of the heating structure and another surface of the heat-conducting member opposite to the one surface is in contact with the wick.
